(19) United States
(12) Patent Application Publication
(10) Pub. No.: US 2023/0254075 A1
(43) Pub. Date: Aug. 10, 2023

(54) METHOD AND APPARATUS FOR TRANSMITTING AND RECEIVING CHANNELS IN DUPLEX MODE

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/160,302

(22) Filed: Jan. 26, 2023

Related U.S. Application Data
(60) Provisional application No. 63/308,386, filed on Feb. 9, 2022.
(60) Provisional application No. 63/324,406, filed on Mar. 28, 2022.

(51) Int. Cl. H04L 5/00; H04L 5/14; H04W 72/0446

(52) U.S. Cl. CPC H04L 5/001; H04L 5/14; H04W 72/0446; H04W 74/0833

(57) ABSTRACT

Apparatuses and methods for transmitting and receiving channels in duplex mode. A method includes receiving information for a location of a sub-band (SB) within a bandwidth (BW), a first set of slots, a second set of slots, and a transmission of a first channel in first frequency resources within the SB over a first set of symbols in a slot of the second set of slots. The second set of slots is included in the first set of slots and does not include slots with receptions of synchronization signals and primary broadcast channel (SS/PBCH) blocks. The method further includes transmitting the first channel within the SB over the first set of symbols in the slot. One or more symbols of the first set of symbols in the slot are downlink (DL) symbols according to the information for the first set of slots.

### CROSS-REFERENCE TO RELATED APPLICATION AND CLAIM OF PRIORITY

This application claims priority under 35 U.S.C. § 119(e) to U.S. Provisional Patent Application No. 63/308,386 filed on Feb. 9, 2022, and U.S. Provisional Patent Application No. 63/324,406 filed on Mar. 28, 2022. The above-identified provisional patent applications are hereby incorporated by reference in their entirety.

### TECHNICAL FIELD

The present disclosure relates generally to wireless communication systems and, more specifically, to transmitting and receiving channels in duplex mode and timing aspects for random access with multiple beams.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for transmitting and receiving channels in duplex mode and timing aspects for random access with multiple beams.

In one embodiment, a user equipment (UE) is provided. The UE includes a transceiver configured to receive information for a location of a sub-band (SB) within a bandwidth (BW), a first set of slots, a second set of slots, and a transmission of a first channel in first frequency resources within the SB over a first set of symbols in a slot of the second set of slots. The second set of slots is included in the first set of slots and does not include slots with receptions of synchronization signals and primary broadcast channel (SS/PBCH) blocks. The transceiver is further configured to transmit the first channel within the SB over the first set of symbols in the slot. One or more symbols of the first set of symbols in the slot are downlink (DL) symbols according to the information for the first set of slots.

In another embodiment, a base station (BS) is provided. The BS includes a transceiver configured to transmit information for a location of a SB within a BW, a first set of slots, a second set of slots, and a reception of a first channel in first frequency resources within the SB over a first set of symbols in a slot of the second set of slots. The second set of slots is included in the first set of slots and does not include slots with transmissions of SS/PBCH blocks. The transceiver is further configured to receive the first channel within the SB over the first set of symbols in the slot, wherein one or more symbols of the first set of symbols in the slot are DL symbols according to the information for the first set of slots.

In yet another embodiment, a method is provided. The method includes receiving information for a location of a SB within a BW, a first set of slots, a second set of slots, and a transmission of a first channel in first frequency resources within the SB over a first set of symbols in a slot of the second set of slots. The second set of slots is included in the first set of slots and does not include slots with receptions of SS/PBCH blocks. The method further includes transmitting the first channel within the SB over the first set of symbols in the slot. One or more symbols of the first set of symbols in the slot are DL symbols according to the information for the first set of slots.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example where a UE transmits a first PRACH preamble in a first RO with a first spatial setting and a second PRACH preamble in a second RO with a second spatial setting according to embodiments of the present disclosure;

FIG. 7 illustrates an example method for a UE to monitor for RARs corresponding to multiple PRACH transmissions in sequential RAR windows according to embodiments of the present disclosure;

FIG. 8 illustrates an example for two PRACH transmissions where the UE monitors for RARs in time intervals within a single RAR window that a MAC entity starts after transmission of a first PRACH and terminates after transmission of a last PRACH according to embodiments of the present disclosure;

FIG. 9 illustrates an example method for a UE to monitor for RARs corresponding to multiple PRACH transmissions in sequential time intervals of a RAR window according to embodiments of the present disclosure;

FIG. 10 illustrates an example of Msg3 PUSCH transmission corresponding to an UL grant received in response to a first PRACH transmission in a first RO with a first spatial setting according to embodiments of the present disclosure.

FIG. 11 illustrates an example method for a UE to transmit a Msg3 PUSCH according to embodiments of the present disclosure;

FIG. 12 illustrates an example for a UE to transmit a number of PRACH transmissions using a first spatial setting and then transmit the same number of PRACH transmissions using a second spatial setting according to embodiments of the present disclosure;

FIG. 13 illustrates an example of a slot configuration according to embodiments of the present disclosure;

FIG. 14 illustrates another example of a slot configuration according to embodiments of the present disclosure;

FIG. 15 illustrates yet another example of a slot configuration according to embodiments of the present disclosure;

FIG. 16 illustrates an example method for a UE configured for XDD operation to determine available slots for a PUSCH transmission with repetitions when a counting of number of repetitions is based on available slots according to embodiments of the present disclosure;

FIG. 17 illustrates an example method for a UE configured for operation in duplex mode to determine the direction of time and frequency resources based on a dynamic indication according to embodiments of the present disclosure;

FIG. 18 illustrates an example method for a UE configured for operation in duplex mode to determine the direction of time and frequency resources based on a dynamic indication according to embodiments of the present disclosure; and

FIG. 19 illustrates an example method for a UE configured for XDD operation to determine available slots for a PUSCH transmission with repetitions when a counting of number of repetitions is based on available slots according to embodiments of the present disclosure.

### DETAILED DESCRIPTION

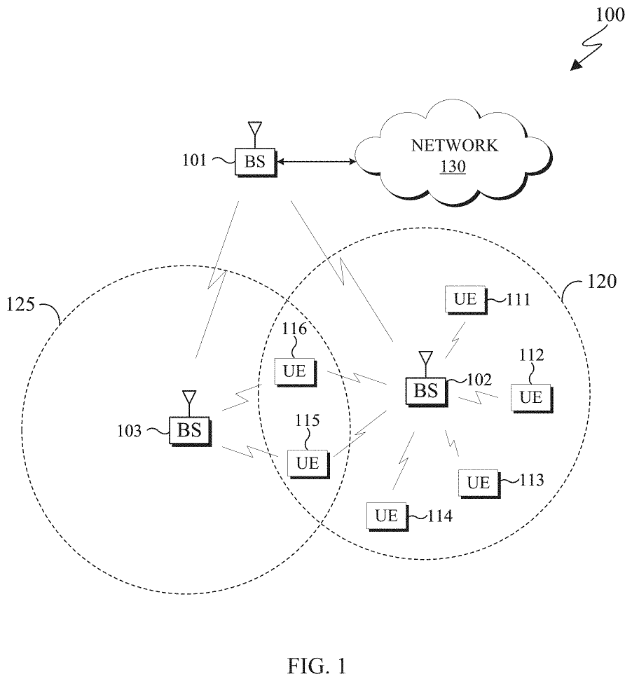

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.3.0, “NR; Physical channels and modulation” (“REF1”); 3GPP TS 38.212 v17.3.0, “NR; Multiplexing and channel coding” (“REF2”); 3GPP TS 38.213 v17.3.0, “NR; Physical layer procedures for control” (“REF3”); 3GPP TS 38.214 v17.3.0, “NR; Physical layer procedures for data” (“REF4”); 3GPP TS 38.321 v17.2.0, “NR; Medium Access Control (MAC) protocol specification” (“REF5”); and 3GPP TS 38.331 v17.2.0, “NR; Radio Resource Control (RRC) protocol specification” (“REF6”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmitting and receiving channels in duplex mode and timing aspects for random access with multiple beams. In certain embodiments, one or more of the BSs 101-103 include circuitry, programing, or a combination thereof for transmitting and receiving channels in duplex mode and timing aspects for random access with multiple beams.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

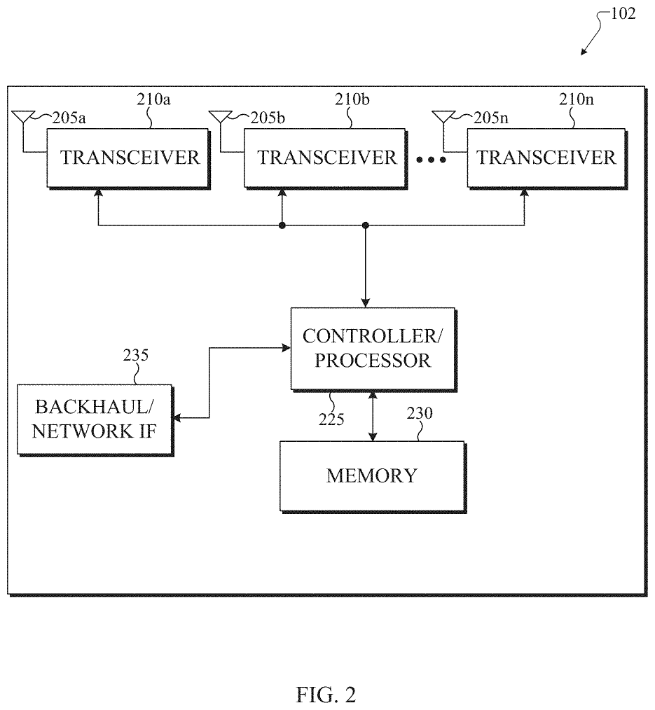

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission in full duplex systems. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

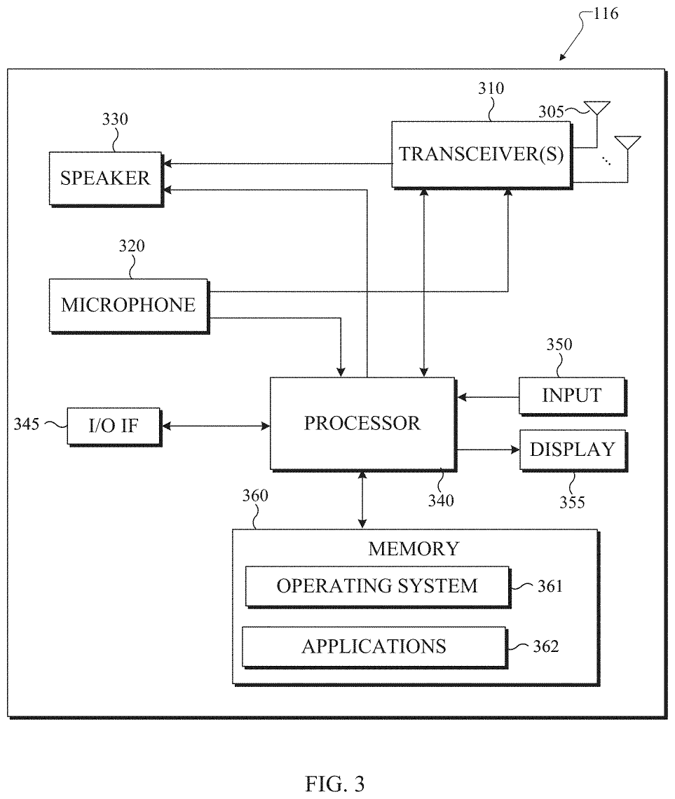

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

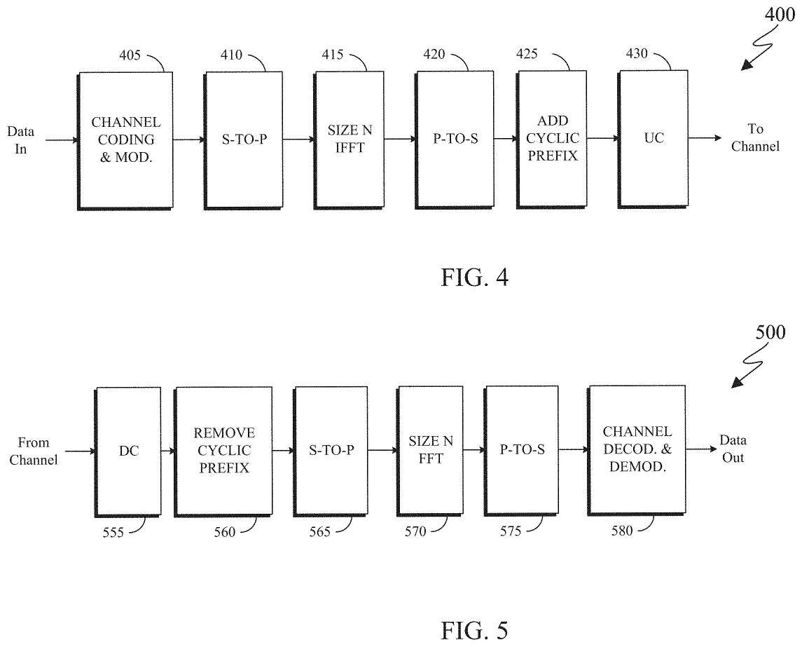

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support transmitting and receiving channels in duplex mode and timing aspects for random access with multiple beams as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A random access (RA) procedure can be initiated by radio resource control (RRC) for a system information (SI) request if a system information block 1 (SIB1) includes scheduling information for an on-demand SI request, by a medium access control (MAC), or by a Physical Downlink Control Channel (PDCCH) order. The RA procedure can be initiated due to a variety of triggers or purposes. For example, the RA procedure can be initiated for initial access to establish an RRC connection, where a user equipment (UE) transitions from an RRC IDLE state to an RRC CONNECTED state, to re-establish an RRC connection after radio link failure (RLF), for an on-demand SI request, or for hand-over. In addition, the RA procedure can be initiated for purposes such as uplink (UL) synchronization, scheduling request (SR), positioning, or link recovery referred to herein as beam failure recovery (BFR).

The RA can operate in at least two modes. A first mode is contention-based random access (CBRA) where UEs transmitting to a same serving cell can share same RA resources and, accordingly, there is a possibility of collision among RA attempts from different UEs. A second mode is contention-free random access (CFRA) where a UE has dedicated RA resources that are indicated by a serving gNB and may not be shared with other UEs so that RA collisions can be avoided.

A four-step RA procedure, also known as a Type-1 (L1) random access procedure, includes a transmission of a physical random access channel (PRACH) preamble (Msg1), an attempt to receive a random access response (RAR or Msg2), a transmission of a contention resolution message (Msg3), and an attempt to receive a contention resolution message (Msg4). An alternative RA procedure can include only two steps, referred to herein as two-step RACH or a Type-2 L1 random access procedure. In two step RACH, Msg1 and Msg3 are combined into a MsgA transmission and Msg2 and Msg4 above are combined into a MsgB reception. MsgA combines a PRACH preamble transmission in a RACH occasion (RO) along with a PUSCH transmission in a so-called PUSCH occasion (PO). The mapping between ROs and POs can be one-to-one, many-to-one, or one-to-many.

The present disclosure considers a four-step RA procedure and embodiments for determining a timeline for transmissions and receptions during random access when a PRACH preamble is transmitted in an RO with a spatial setting herein described for four-step RACH can generally apply also to determining a timeline for a MsgA transmission for a two-step RACH. Descriptions of transmission settings for a Msg3 PUSCH transmission upon reception of a RAR for four-step RACH can apply to a PUSCH transmission upon reception of a RAR indicating a successful decoding of the MsgA PUSCH transmission for the two-step RACH.

During initial cell search, a UE acquires/detects a synchronization signal/physical broadcast channel (SS/PBCH) block transmitted by a serving gNB. The gNB can transmit multiple SS/PBCH blocks with different quasi-collocation properties (beams). The UE typically acquires a SS/PBCH block corresponding to a largest signal to interference and noise ratio (SINR). In case of reciprocal reception/transmission quasi-collocation properties at the UE, the SS/PBCH block that the UE detects has quasi-collocation properties that best match the ones of transmissions from the UE. Then, the UE can transmit PRACH according to the spatial setting that is determined from the detected SS/PBCH block.

The UE can transmit a PRACH with a narrow beam and change the spatial setting of the PRACH transmission when the UE does not detect a RAR message addressing the UE in response to a PRACH transmission. The UE can also perform sweeping over multiple spatial settings for PRACH transmissions before attempting to detect a RAR message. The gNB may be able to detect one or more of the UE transmissions, and based on the configuration of the PRACH transmission, the gNB can transmit one or more RARs to the UE. When the UE does not receive a RAR, either because the gNB has not detected a PRACH preamble from the UE, for example because a corresponding spatial setting used by the UE does not provide sufficiently large SINR, or because although the gNB has successfully detected the PRACH preamble from the UE and has transmitted a RAR to the UE, the UE has not received the RAR, for example because a corresponding spatial setting used by the gNB does not provide sufficiently large SINR, the UE may restart the RA procedure by transmitting one or more PRACH preambles using a spatial setting or using multiple spatial settings. When a RAR is successfully received by the UE, the UE transmits a Msg3. When the Msg3 is not correctly received by the gNB, the UE may have transmitted Msg3 using a spatial setting that does not provide sufficiently large SINR. The gNB can schedule a Msg3 retransmission from the UE, but the Msg3 retransmission from the UE would typically need to be with a spatial setting that provides sufficiently large SINR in order to be correctly received by the gNB.

Therefore, there is a need to define timelines for a UE to transmit multiple PRACH transmissions using multiple spatial settings, to receive one or more RAR messages in response to corresponding PRACH transmissions, and to transmit a Msg3 PUSCH that is received with a sufficiently large SINR at a serving gNB.

The present disclosure relates to a random access procedure for a user equipment (UE) to establish RRC connection with a serving gNB wherein the random access procedure includes a transmission of a PRACH from the UE, a RAR reception by the UE in response to the PRACH transmission and, for a contention based random access, a Msg3 PUSCH transmission from the UE for contention resolution. The disclosure relates to determining timing relationships for PRACH transmissions, RAR receptions and Msg3 PUSCH transmissions when the UE operates with multiple spatial settings on multiple cells, such as for operation with carrier aggregation, or on multiple transmission/reception points (TRPs). The disclosure also relates to determining one or more RAR windows for monitoring RARs receptions corresponding to PRACH transmissions with multiple spatial settings. The disclosure further relates to determining timing relationships when the UE transmits multiple PRACH transmissions with same and different spatial settings.

When a UE is configured for initiating a random access procedure, the UE receives from higher layers a configuration for a PRACH transmission comprising a preamble index, a preamble SCS, a transmission power P_{PRACH,target}, a corresponding RA-RNTI, and a PRACH resource. The UE determines a power for a PRACH transmission on the indicated PRACH resource. The UE can be provided a number N of SS/PBCH block indices associated with one RO and a number R of contention based preambles per SS/PBCH block index per valid RO by ssb-perRACH-OccasionAndCB-PreamblesPerSSB. Depending on the configured values of N and R and on an ordering of preamble indices within a single RO, frequency resource indices for frequency multiplexed ROs, time resource indices for time multiplexed ROs within a PRACH slot and indices for PRACH slots, the UE determines valid ROs associated with SS/PBCH block indices and PRACH preamble indices.

ROs are mapped consecutively per corresponding SS/PBCH block index. For a PRACH transmission the UE selects the RO indicated by a PRACH mask index value for the indicated SS/PBCH block index. For PRACH transmissions with multiple spatial settings, the UE can select PRACH preambles and ROs from the determined set of PRACH preambles associated to SS/PBCH block indices, and transmit PRACH transmissions using different spatial settings.

A UE can be configured to transmit PRACH using S spatial settings, wherein the value S is configured in SIB and can be a field in the Information Element (IE) RACH-ConfigCommon that is used to specify the cell specific random access parameters or in IE RACH-ConfigGeneric that is used to specify the random access parameters for regular random access and for beam failure recovery. It is also possible that the value S indicates a maximum number of spatial settings that a UE can use for PRACH transmissions. Then the UE determines the number of spatial settings and the spatial settings to be used for PRACH transmissions based on RSRP measurements of SS/PBCH blocks, and/or of receptions of CSI-RS resource, if configured. In this disclosure S is used for the configured or actual number of spatial settings for PRACH transmissions interchangeably.

In one example of PRACH transmission, the association SS/PBCH block indexes and ROs is a 1-to-1 mapping, and one PRACH preamble is associated to an RO. When a UE is configured to transmit using S spatial settings, (a) the UE can transmit S PRACH preambles in S ROs by cycling over S spatial settings, or (b) the UE can repeat a number of times the transmission of a first PRACH preamble in a first RO using a first spatial setting, and then repeat the same number of times the transmission of a second PRACH preamble in a second RO using a second spatial setting, and so on until transmitting an S-th PRACH preamble in an S-th RO with an S-th spatial settings, or (c) the UE can transmit S PRACH preambles in corresponding S ROs by cycling over different S spatial settings, and then repeat the S transmissions a number of times.

In another example of PRACH transmission, an SS/PBCH block index is associated to multiple ROs, and each RO of the multiple ROs is associated to a same PRACH preamble, and the UE can transmit the PRACH preamble in the different ROs using the S spatial settings as described in (a), (b) or (c) above.

In yet another example of PRACH transmission, an SS/PBCH block index is associated to multiple ROs, and each RO of the multiple ROs is associated to different PRACH preambles, and the UE can transmit the PRACH preambles in the different ROs using the S spatial settings as described in (a), (b) or (c) above.

In response to a PRACH transmission, a UE attempts to detect a DCI format 1_0 with CRC scrambled by a corresponding RA-RNTI during a RAR window controlled by higher layers. For multiple PRACH transmissions with different spatial settings, the UE is configured multiple search space sets associated with different TCI states, corresponding to different spatial settings, configured for different CORESETs where the UE receives multiple PDCCHs for the corresponding multiple search space sets. When the UE transmits multiple PRACH transmissions with different spatial settings, the UE can be configured with one or multiple RAR windows. For example, when a UE is configured to transmit with a first and a second spatial setting, wherein one or multiple PRACH transmission(s) is/are transmitted with the first spatial setting and one or multiple PRACH transmission(s) is/are transmitted with the second spatial setting, a first RAR window can be configured for attempting reception of one or multiple RARs corresponding to the one or multiple PRACH transmissions with the first spatial setting, and a second RAR window can be configured for attempting reception of one or multiple RARs corresponding to the one or multiple PRACH transmissions with the second spatial setting or equivalently, associated with a first TCI state. A length of the first and second RAR window can be same or different, and can be provided by ra-ResponseWindow-TCI. The parameter ra-ResponseWindow-TCI can provide one value for the length of the RAR window that applies to both the first RAR window and to the second RAR window, wherein first and second RAR windows correspond to monitoring for RARs to PRACH transmissions with first and second spatial settings, respectively. It is also possible that different RAR window lengths are provided for RAR windows corresponding to PRACH transmission with different spatial settings. For example, ra-ResponseWindow-TCI can provide a first value for the length of the first RAR window associated with the first TCI state corresponding to the first spatial setting, and a second value for the length of the second RAR window associated with the second TCI state corresponding to the second spatial setting. Similarly, when the UE transmits with S spatial settings, ra-ResponseWindow-TCI can provide same or different RAR window lengths for the corresponding S RAR windows that can be configured per UL BWP. It is also possible that separate higher layer parameters are used to provide the length of each RAR window, and be configured per spatial setting. The UE can also be configured with one RAR window for monitoring RARs corresponding to any of the PRACH transmissions with same or different spatial settings. The length of the RAR window in number of slots can be provided by ra-ResponseWindow which can be a separate parameter from the parameter that indicates the length of the RAR window when the UE transmits one or more PRACH preambles in one or more ROs with a same spatial setting. It is also possible that the configuration of multiple RAR windows (with either same or different RAR window length) depends on the UE operating on multiple cells, such as for operation with carrier aggregation, or operating with multiple transmission/reception points (TRPs) with single or multiple transmission panels, wherein simultaneous transmission from multiple panels may or may not be possible, or may or may not be configured.

When a UE is configured to transmit PRACH transmissions using multiple spatial settings, the UE can transmit a first PRACH preamble in a first RO with a first spatial setting and a second PRACH preamble in a second RO with a second spatial setting. In response to the first PRACH transmission of the first PRACH preamble in the first RO with the first spatial setting, the UE attempts to detect a DCI format 1_0 with CRC scrambled by a corresponding RA-RNTI during a first RAR window that starts at the first symbol of the earliest CORESET the UE is configured to receive PDCCH for Type1-PDCCH CSS set associated with the first spatial setting, or equivalently to a corresponding first TCI state, that is at least one symbol, after the last symbol of the first RO corresponding to the first PRACH transmission with the first spatial setting. The window starts after an additional T_{TA}+k_{mac} msec where T_{TA} is a timing advance between downlink and uplink and k_{mac} is a number of slots provided by K-Mac or k_{mac}=0 if K-Mac is not provided. In response to the second PRACH transmission of the second PRACH preamble in the second RO with the second spatial setting, the UE attempts to detect a DCI format 1_0 with CRC scrambled by a corresponding RA-RNTI during a second RAR window that starts at the first symbol of the earliest CORESET (associated with the search space set configured for the second TCI state) the UE is configured to receive PDCCH for Type1-PDCCH CSS set associated with the second spatial setting, or equivalently to a corresponding second TCI state, that is at least one symbol, after the last symbol of the second RO corresponding to the second PRACH transmission with the second spatial setting.

If the UE does not detect the DCI format 1_0 with CRC scrambled by the corresponding RA-RNTI within the first RAR window, or if the UE detects the DCI format 1_0 with CRC scrambled by the corresponding RA-RNTI within the first RAR window and LSBs of a SFN field in the DCI format 1_0, if included and applicable, are not same as corresponding LSBs of the SFN where the UE transmitted PRACH, or if the UE does not correctly receive the transport block in the corresponding PDSCH within the first window, or if the higher layers do not identify the RAPID associated with the PRACH transmission from the UE, then the PRACH transmission is considered not successful.

If the UE detects the DCI format 1_0 with CRC scrambled by the corresponding RA-RNTI within the first RAR window and LSBs of a SFN field in the DCI format 1_0, if included and applicable, are same as corresponding LSBs of the SFN where the UE transmitted the first PRACH preamble in the first RO with the first spatial setting, and the UE receives a transport block in a corresponding PDSCH within the first window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer, and the PRACH transmission is considered successful.

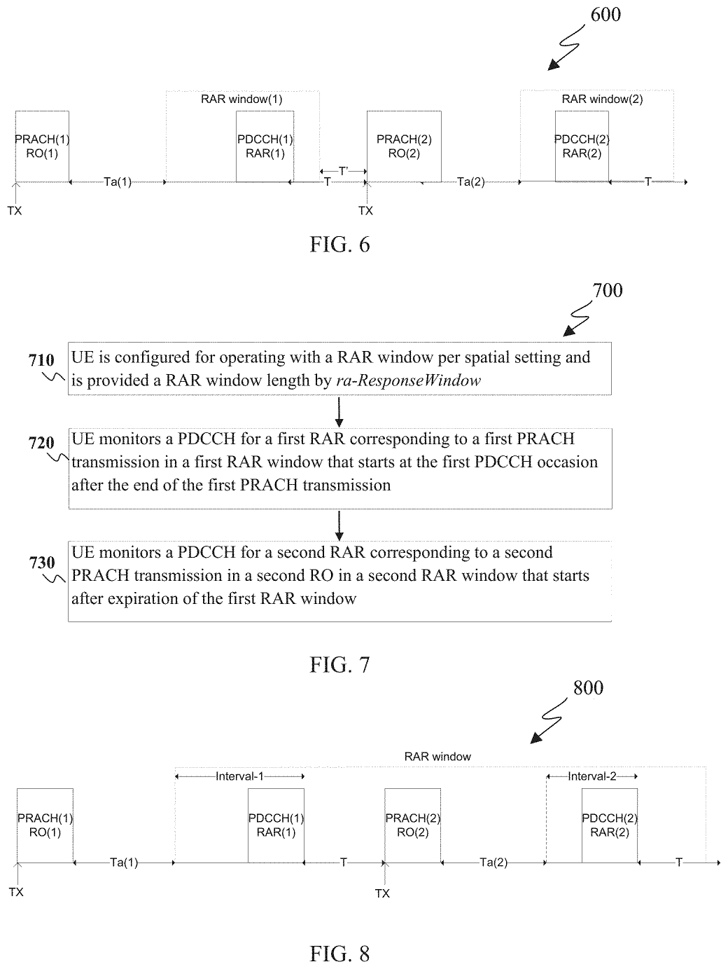

FIG. 6 illustrates an example 600 where a UE transmits a first PRACH preamble in a first RO with a first spatial setting and a second PRACH preamble in a second RO with a second spatial setting according to embodiments of the present disclosure. The embodiment of the example 600 where a UE transmits a first PRACH preamble in a first RO with a first spatial setting and a second PRACH preamble in a second RO with a second spatial setting illustrated in FIG. 6 is for illustration only. FIG. 6 does not limit the scope of this disclosure to any particular implementation of the example where a UE transmits a first PRACH preamble in a first RO with a first spatial setting and a second PRACH preamble in a second RO with a second spatial setting.

In the example illustrated in FIG. 6, where the UE transmits a first PRACH preamble in a first RO with a first spatial setting and a second PRACH preamble in a second RO with a second spatial setting, the UE is configured a RAR window length by parameter ra-Response Window in RACH-ConfigCommon. Upon transmission of the first PRACH preamble in the first RO with the first spatial setting, the MAC entity starts a first RAR window at the first PDCCH occasion after the end of the first PRACH preamble transmission in the first RO (time interval Ta(1)), and monitors a PDCCH for a RAR while the RAR window is running. If the UE receives an UL grant during the RAR window or the UE does not receive a RAR and the first RAR window expires, the second PRACH preamble can be transmitted in the second RO with the second spatial setting wherein the second RO is the next available RO for transmission of the second PRACH preamble after the last symbol of the PDSCH reception conveying the RAR message with the RAR UL grant (time interval T) or after the RAR window expires (time interval T′). After reception of the first RAR during the first RAR window or after a maximum time interval equal to the configured length of the RAR window, the MAC entity stops the monitoring for RARs and terminates the RAR window. A second RAR window for monitoring a RAR corresponding to the second PRACH preamble transmission starts at the PDCCH occasion after the end of the first PRACH preamble transmission in the first RO (time interval Ta(2)).

FIG. 7 illustrates an example method 700 for a UE to monitor for RARs corresponding to multiple PRACH transmissions in sequential RAR windows according to embodiments of the present disclosure. The embodiment of the example method 700 for a UE to monitor for RARs corresponding to multiple PRACH transmissions in sequential RAR windows illustrated in FIG. 7 is for illustration only. FIG. 7 does not limit the scope of this disclosure to any particular implementation of the example method for a UE to monitor for RARs corresponding to multiple PRACH transmissions in sequential RAR windows.

As illustrated in FIG. 7, at step 710, a UE (such as the UE 116) is configured for operating with a RAR window per spatial setting and is provided a RAR window length by ra-ResponseWindow. At step 720, the UE monitors a PDCCH for a first RAR corresponding to a first PRACH transmission in a first RO in a first RAR window that starts at the first PDCCH occasion after the end of the first PRACH transmission. At step 730, the UE monitors a PDCCH for a second RAR corresponding to a second PRACH transmission in a second RO in a second RAR window that starts after expiration of the first RAR window. At step 730 the expiration of the first RAR window can occur after the UE receives the first RAR with the UL grant or after the maximum length of the RAR window is reached and no UL grant was received by the UE.

Referring back to FIG. 6, it is also possible that after reception of the first RAR during the first RAR window that the MAC entity started at the first PDCCH occasion after the end of the first PRACH preamble transmission in the first RO, the UE stops attempting to detect RAR corresponding to the first PRACH transmission but the MAC entity does not terminate the first RAR window. The same RAR window is running until the UE monitors for RAR corresponding to a last PRACH transmission. After the last PRACH transmission, the UE starts monitoring for RAR corresponding to the last PRACH transmission at the PDCCH occasion after the end of the last PRACH preamble transmission in the last RO and the MAC entity terminates the RAR window after reception of a RAR message corresponding to the last PRACH transmission or if the RAR is not received after a maximum time interval Tw from the start of the monitoring for RAR corresponding to the last PRACH transmission. The maximum time Tw also applies for monitoring of any of the PRACH transmissions.

FIG. 8 illustrates an example 800 for two PRACH transmissions where the UE monitors for RARs in time intervals within a single RAR window that a MAC entity starts after transmission of a first PRACH and terminates after transmission of a last PRACH according to embodiments of the present disclosure. The embodiment of the example 800 for two PRACH transmissions where the UE monitors for RARs in time intervals within a single RAR window that a MAC entity starts after transmission of a first PRACH and terminates after transmission of a last PRACH illustrated in FIG. 8 is for illustration only. FIG. 8 does not limit the scope of this disclosure to any particular implementation of the example for two PRACH transmissions where the UE monitors for RARs in time intervals within a single RAR window that a MAC entity starts after transmission of a first PRACH and terminates after transmission of a last PRACH.

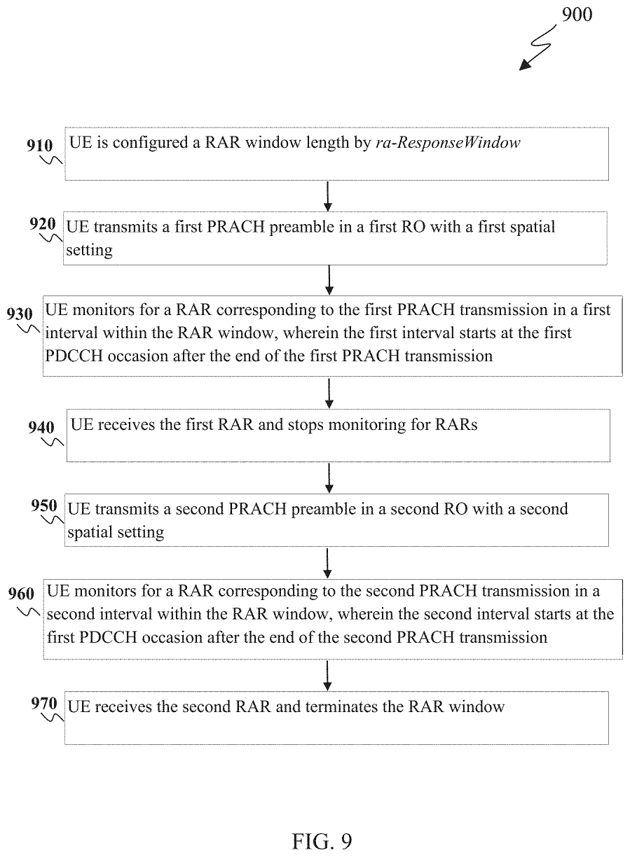

FIG. 9 illustrates an example method 900 for a UE to monitor for RARs corresponding to multiple PRACH transmissions in sequential time intervals of a RAR window according to embodiments of the present disclosure. The embodiment of the example method 900 for a UE to monitor for RARs corresponding to multiple PRACH transmissions in sequential time intervals of a RAR window illustrated in FIG. 9 is for illustration only. FIG. 9 does not limit the scope of this disclosure to any particular implementation of the example method for a UE to monitor for RARs corresponding to multiple PRACH transmissions in sequential time intervals of a RAR window.

As illustrated in FIG. 9, at step 910, a UE (such as the UE 116) is configured a RAR window length by ra-Response Window. At step 920, the UE transmits a first PRACH preamble in a first RO with a first spatial setting. At step 930, the UE monitors for a RAR corresponding to the first PRACH transmission in a first interval within the RAR window, wherein the first interval starts at the first PDCCH occasion after the end of the first PRACH transmission. At step 940, the UE receives the first RAR and stops monitoring for RARs. At step 950, the UE transmits a second PRACH preamble in a second RO with a second spatial setting. At step 960, the UE monitors for a RAR corresponding to the second PRACH transmission in a second interval within the RAR window, wherein the second interval starts at the first PDCCH occasion after the end of the second PRACH transmission. At step 970, the UE receives the second RAR and terminates the RAR window.

Alternatively, in step 940 the UE does not receive a RAR during an interval with a configured or default duration, wherein the interval starts at the first PDCCH occasion after the end of the first PRACH transmission, and stops monitoring for RAR. Alternatively, in step 970, the UE does not receive a RAR during an interval with a configured or default duration, wherein the interval starts at the first PDCCH occasion after the end of the second PRACH transmission, and terminates the RAR window. The termination of the RAR window occurs after the last PRACH transmission. For example, if a UE transmits N PRACH preambles in N ROs with N spatial settings, the UE monitors for RAR in N intervals within the RAR window that is terminated after the last interval for monitoring RAR after the last PRACH transmission.

When a UE transmits a first PRACH preamble in a first RO with a first spatial setting and a second PRACH preamble in a second RO with a second spatial setting, and receives a first RAR message that schedules a Msg3 PUSCH transmission, there can be a need to transmit the Msg3 PUSCH without overlapping with the transmission of the second PRACH preamble.

For transmissions from a UE operating on multiple cells, such as for operation with carrier aggregation, or operating with multiple transmission/reception points (TRPs), wherein a TRP is defined by a spatial setting for a reception by the UE (transmission point) or for a transmission from the UE (reception point) and different reception points can be reception points of different cells or of a same serving cell, if the UE is equipped with a single transmission panel and transmits with one spatial setting at a time, a Msg3 PUSCH scheduled by a RAR corresponding to a first PRACH transmission with a first spatial setting needs not to overlap with a second PRACH transmission with a second spatial setting.

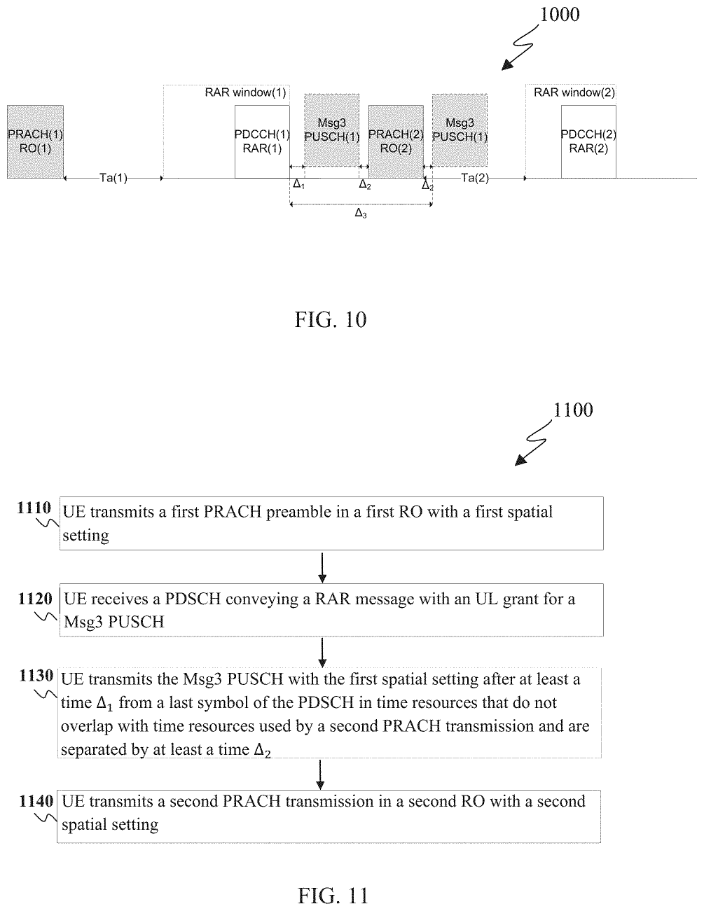

FIG. 10 illustrates an example 1000 of Msg3 PUSCH transmission corresponding to an UL grant received in response to a first PRACH transmission in a first RO with a first spatial setting according to embodiments of the present disclosure. The embodiment of the example 1000 of Msg3 PUSCH transmission corresponding to an UL grant received in response to a first PRACH transmission in a first RO with a first spatial setting illustrated in FIG. 10 is for illustration only. FIG. 10 does not limit the scope of this disclosure to any particular implementation of the example of Msg3 PUSCH transmission corresponding to an UL grant received in response to a first PRACH transmission in a first RO with a first spatial setting.

As illustrated in FIG. 10, the transmission of the Msg3 PUSCH can start after a minimum time Δ₁ from the last symbol of a PDSCH reception conveying a RAR message with a RAR UL grant for the Msg3 PUSCH, wherein the minimum time Δ₁ is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 assuming that N₁ and N₂ correspond to the smaller of the SCS configurations for the PDSCH and the PUSCH. The transmission of the Msg3 PUSCH with the first spatial setting should be completed a time duration Δ₂ before the start of the second PRACH preamble transmission corresponding to a preparation time for switching spatial setting. The Msg3 PUSCH can be transmitted before the start of the second PRACH transmission if there are enough time resources after accounting for the time constraints given by Δ₁ and Δ₂. Otherwise the Msg3 PUSCH is transmitted after a time duration Δ₃ from the last symbol of the PDSCH conveying the corresponding UL grant that considers an additional time Δ₂ for the UE to change spatial setting. Additionally, the timeline for transmission and reception by the UE needs to consider that the UE can use same spatial setting for transmitting PRACH, for receiving the corresponding PDCCH/PDSCH and for transmitting the corresponding Msg3 PUSCH. Thus, a time for the UE to switch spatial setting for transmissions and/or to switch spatial setting for reception and transmission needs to be considered in the timeline for transmission and reception by the UE that may be equipped with a single panel for transmission and/or with single or multiple panels for reception.

FIG. 11 illustrates an example method 1100 for a UE to transmit a Msg3 PUSCH according to embodiments of the present disclosure. The embodiment of the example method 1100 for a UE to transmit a Msg3 PUSCH illustrated in FIG. 11 is for illustration only. FIG. 11 does not limit the scope of this disclosure to any particular implementation of the example method for a UE to transmit a Msg3 PUSCH.

As illustrated in FIG. 11, at step 1110. a UE (such as the UE 116) transmits a first PRACH preamble in a first RO with a first spatial setting. At step 1120, the UE receives a PDSCH conveying a RAR message with an UL grant for a Msg3 PUSCH. At step 1130, the UE transmits the Msg3 PUSCH with the first spatial setting after at least a time Δ₁ from a last symbol of the PDSCH in time resources that do not overlap with time resources used by a second PRACH transmission and are separated by at least a time Δ₂. At step 1140, the UE transmits a second PRACH transmission in a second RO with a second spatial setting after at least a minimum time interval Δ₂.

When a UE is equipped with multiple panels for transmission and can transmit simultaneously on more than one panel, a first Msg3 PUSCH transmission corresponding to a first PRACH transmission with a first spatial setting from a first transmission panel can be scheduled independently of a second PRACH transmission with a second spatial setting from a second transmission panel, and transmission of the first Msg3 PUSCH with the first spatial setting and of the second PRACH transmission with the second spatial setting can be at the same time. If the UE cannot transmit simultaneously on more than one panel, the first Msg3 PUSCH transmission should be scheduled in order to not overlap in time with the second PRACH transmission, and be completed before a time interval Δ₂ from the start of the second PRACH transmission or start after a time interval Δ₂ from the last symbol of the second PRACH transmission for the UE processing time for switching spatial setting and/or transmission panel.

The above descriptions for Msg3 PUSCH transmission consider sequential RAR windows as illustrated in FIG. 6 but are directly applicable to Msg3 PUSCH transmission when monitoring for RARs corresponding to different PRACH transmissions in different ROs with different spatial settings is done by the UE in different time intervals within a configured RAR window as illustrated in FIG. 8.

A UE can repeat a number of times the transmission of a first PRACH preamble in a first RO using a first spatial setting, and then repeat the same number of times the transmission of a second PRACH preamble in a second RO using a second spatial setting, and so on until transmitting an S-th PRACH preamble in an S-th RO with an S-th spatial settings. It is possible that the UE transmits different PRACH preambles in different ROs in each spatial setting. It is also possible that the UE repeats a number of times the transmission of a first PRACH preamble in different ROs using a first spatial setting and then repeats the same number of times a second PRACH preamble in different ROs using a second spatial setting, and so on.

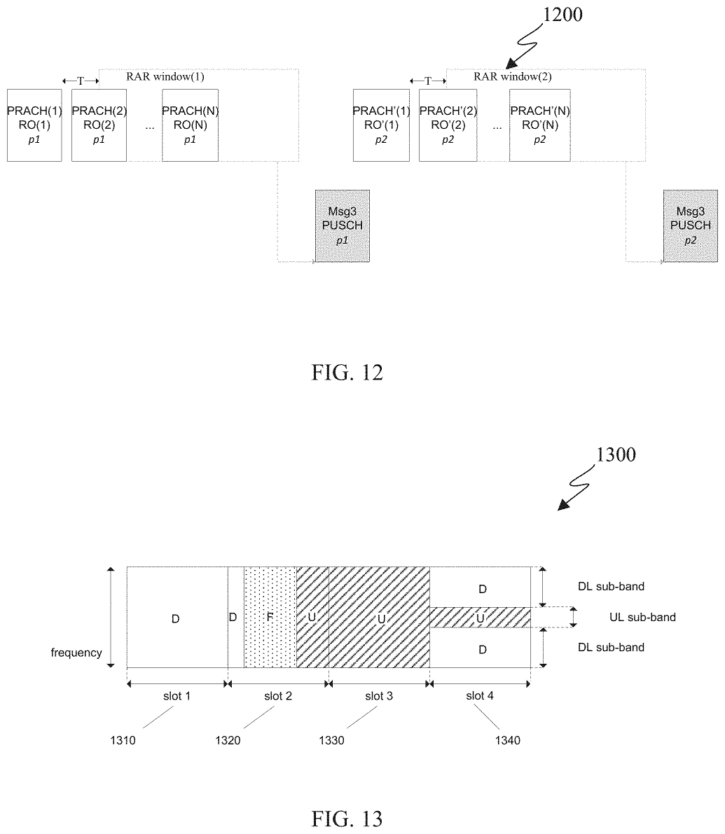

FIG. 12 illustrates an example 1200 for a UE to transmit a number of PRACH transmissions using a first spatial setting and then transmit the same number of PRACH transmissions using a second spatial setting according to embodiments of the present disclosure. The embodiment of the example 1200 for a UE to transmit a number of PRACH transmissions using a first spatial setting and then transmit the same number of PRACH transmissions using a second spatial setting illustrated in FIG. 12 is for illustration only. FIG. 12 does not limit the scope of this disclosure to any particular implementation of the example for a UE to transmit a number of PRACH transmissions using a first spatial setting and then transmit the same number of PRACH transmissions using a second spatial setting.

As illustrated in FIG. 12, when a UE transmits a number of PRACH transmissions with a first spatial setting and then transmits the same number of PRACH transmissions with a second spatial setting, and so on, the UE can be configured with a first RAR window for monitoring RARs corresponding to the multiple PRACH transmissions with the first spatial setting, and a second RAR window for monitoring RARs corresponding to the multiple PRACH transmissions with the second spatial setting, and so on. A Msg3 PUSCH transmission scheduled by an UL grant conveyed by a RAR message of a PDSCH reception in the first RAR window is transmitted with a first spatial setting in time resources that may or may not need not to overlap with PRACH transmissions with a second spatial setting depending on whether the UE is equipped with single or multiple TX panels and whether the UE can transmit simultaneously from more than one panel.

In other embodiments, the present disclosure relates to uplink transmissions for a UE capable of operating in duplex mode. The present disclosure relates to determining an availability of an XDD slot for a PUSCH or PUCCH transmission and a counting of repetitions. The present disclosure also relates to determining UL or DL time and frequency resources of the XDD slot after an UL transmission is postponed or dropped. The present disclosure also relates to determining the availability of the XDD slot for UL transmission based on RRC configuration and/or indication of a slot format by a DCI format. Embodiments in this disclosure described for PUSCH transmission equally apply to other uplink transmissions, wherein the uplink transmission is dynamically scheduled by a DCI format or by a RAR uplink grant or semi-statically configured, or is a PUSCH transmission with PUSCH type A or type B repetitions, or is a PUSCH transmission of a transport block over multiple slots (TBoMS), or is a PUCCH transmission with or without repetitions.

A slot format includes downlink symbols, uplink symbols, and flexible symbols. If a UE is provided tdd-UL-DL-ConfigurationCommon, the UE sets the slot format per slot over a number of slots as indicated by tdd-UL-DL-ConfigurationCommon. If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon. A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are common to each configured BWP. A UE considers symbols in a slot indicated as downlink by tdd-UL-DL-ConfigurationCommon, or tdd-UL-DL-ConfigurationDedicated to be available for receptions and considers symbols in a slot indicated as uplink by tdd-UL-DL-ConfigurationCommon, or by tdd-UL-DL-ConfigurationDedicated to be available for transmissions.

An NR TDD component carrier (CC) is a single carrier that uses a same frequency band for the uplink and the downlink. TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that channel state information (CSI) can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the usually small portion of time resources available for UL transmissions, while with FDD all time resources can be used for UL transmissions. Another disadvantage is latency. In TDD, a timing gap between DL reception and UL transmission containing the hybrid automatic repeat request acknowledgement (HARQ-ACK) information associated with DL receptions is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, a dynamic adaptation of link direction has been considered where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF 3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross-link interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a full-duplex wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused or only respective subsets can be active for transmissions and receptions when FD communication is enabled.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC.

Furthermore, a gNB can operate with full-duplex mode even when a UE still operates in half-duplex mode, such as when the UE can either transmit or receive at a same time, or the UE can also be capable for full-duplex operation.

Full-duplex transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel cross-link interference (CLI) and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Full-duplex operation in NR can improve spectral efficiency, link robustness, capacity, and latency of UL transmissions. In an NR TDD system, UL transmissions are limited by fewer available transmission opportunities than DL receptions. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any UL transmission can only occur in a limited number of UL slots, for example every 2, 2.5, or 5 msec, respectively.

Throughout the disclosure, a UE operating in full-duplex (HD) or half-duplex (HD) mode, or in sub-band full duplex or in sub-band non-overlapping full duplex (SBFD) mode, is also referred as an XDD UE or a SBFD UE or a SBFD aware UE or a SB UE. The terms “full-duplex”, “half-duplex”, “sub-band full duplex”, “sub-band non-overlapping full duplex” and “XDD” are used interchangeably in this disclosure to refer to simultaneous DL and UL operation within a TDD carrier by using different TDD configurations across different frequency regions of a BWP, or across different sub-bands of one or more BWP, or also different frequency regions of different BWPs, wherein a frequency region can comprise part or all of the subcarriers of a BWP.

FIG. 13 illustrates an example of a slot configuration 1300 according to embodiments of the present disclosure. The embodiment of the example slot configuration 1300 illustrated in FIG. 13 is for illustration only. FIG. 13 does not limit the scope of this disclosure to any particular implementation of the example slot configuration.

When a UE operates in TDD mode and is provided a TDD UL-DL configuration, a slot can be a downlink slot with all downlink symbols, or an uplink slots with all uplink symbols, or a slot with downlink, and/or flexible symbols, and/or uplink symbols. As illustrated in FIG. 13, a slot can be configured with all downlink symbols 1310, or with downlink symbols, flexible symbols and uplink symbols 1320, or with all uplink symbols 1330, wherein each symbol comprises any of the frequency resources in a configured BWP. When a UE operates in XDD mode, a slot can be also configured with sub-bands of a BWP 1340, wherein each symbol of the slot can be either a DL symbol in the DL sub-band or an UL symbol in the UL sub-band. The slot where there is at least one sub-band for UL and one sub-band for DL is called an XDD slot or an X slot or an SBFD slot. One or more sub-bands for uplink and one or more sub-bands for downlink can occupy different parts of a BWP. For example, a sub-band for uplink can occupy the middle portion of the BWP and the downlink sub-bands can occupy the lower and higher parts of a BWP. Uplink and downlink sub-bands can have different sizes.

Throughout this remainder of the present disclosure, an operation in non-XDD mode refers to a UE that is configured an UL-DL TDD slot format configuration and can transmit/receive a symbol in any of the frequency resources of active UL/DL BWPs; and an operation in XDD mode refers to a UE that is configured an XDD or SBFD or SB slot format configuration that can include UL, DL or XDD or SBFD or SB slots.

A UE can operate in XDD mode during connected mode and/or initial access or for some steps of a random access (RA) procedure. While a RA procedure in non-XDD mode allows sharing of time and frequency resources among XDD and non-XDD UEs in a cell and reduces system resource fragmentation, operating some or all steps of the RA procedure in XDD mode has the advantage of flexible resource allocation and optimization of UE-specific signaling by allowing simultaneous UL and DL transmissions in different frequency regions or sub-bands of a BWP.

A UE can also operate in XDD mode with different configurations in different time periods. An adaptation over time of an XDD configuration is helpful to mitigate the interference level in a cell and enhance scheduling flexibility. Different sub-bands of a BWP and/or different BWPs, or also different CCs, can be configured for UL or DL in different time periods depending on the load in the cell and on UE capabilities to operate in FD, HD or XDD mode.

For applications that do not require small latency or large data rates, a typical approach to improve coverage is to increase a transmission time; that is, a physical signal or channel can be transmitted over a number of time units corresponding to a number of repetitions or retransmissions. When a UE is in extreme coverage limiting situation, such as when the UE experiences large path loss, relying on repetitions can improve coverage while maintaining an efficient network operation.

When a UE is scheduled to transmit a physical uplink shared channel (PUSCH) that provides a transport block, a value m of a time domain resource assignment (TDRA) field in a downlink control information (DCI) format scheduling the PUSCH transmission provides a row index m+1 to an allocated table. The DCI format is provided in a physical downlink control channel (PDCCH) reception. The indexed row defines a slot offset K₂ for the PUSCH transmission after a slot of the PDCCH reception, possibly after further adjusting by the sub-carrier spacing (SCS) configurations for the PDCCH and the PUSCH, the start and length indicator SLIV, or directly the start symbol S and the symbol allocation length L for the PUSCH transmission, the PUSCH mapping type, and the number of repetitions (if number of repetitions is present in the resource allocation table) for the PUSCH transmission.

For PUSCH repetition Type A, the starting symbol S relative to the start of the slot, and the number of consecutive symbols L counting from the symbol S that is allocated for the PUSCH are determined from the start and length indicator value, SLIV, of the indexed row. When a UE transmits a PUSCH that is scheduled by a DCI format, the UE determines a number of repetitions K from the resource allocation table if higher layer parameter numberofrepetitions is present; otherwise, from a value of higher layer parameter pusch-AggregationFactor. In the following, for brevity, an italicized parameter name refers to a higher layer parameter. The UE repeats the PUSCH transmission across the K consecutive slots by applying a same symbol allocation in each slot. The UE transmits a repetition of the PUSCH transmission in a slot only when L consecutive symbols in the slot, starting from symbol S, are not downlink (DL) symbols. For PUSCH repetition Type B, the starting symbol S relative to the start of the slot, and the number of consecutive symbols L counting from the symbol S allocated for the PUSCH, are provided by startSymbol and length of the indexed row of the resource allocation table, respectively. The number of nominal repetitions is given by numberofrepetitions.

A UE can also repeat a transmission of a physical uplink control channel (PUCCH) in order to improve a reception reliability of uplink control information (UCI) provided by the PUCCH, wherein a repetition of the PUCCH transmission in each slot starts from a same symbol in the slot and is over a same number of consecutive symbols. When there are not enough available symbols in a slot for a repetition of the PUCCH transmission, or when the repetition cannot start from a configured or indicated first symbol, or when the repetition cannot occur in consecutive symbols of a slot, the UE does not transmit the PUCCH repetition in the slot, the UE defers the repetition to a subsequent slots and does not count the slot in the number of configured or indicated slots for repetitions of a PUCCH transmission.

For PUSCH transmissions of PUSCH repetition Type A scheduled by DCI format 0_1 or 0_2 in PDCCH with CRC scrambled with C-RNTI, MCS-C-RNTI, CS-RNTI with NDI=1, PUSCH repetition Type A with a configured grant, PUSCH repetition Type A scheduled by DCI format 0_0 with CRC scrambled by TC-RNTI, PUSCH repetition Type B, PUSCH transmission of TB processing over multiple slots scheduled by DCI format 0_1 or 0_2, or for PUCCH transmissions of a PUCCH repetition, if a symbol of a slot becomes unavailable for transmission of a PUSCH or PUCCH repetition in the slot, the UE does not transmit the repetition. The unavailability of a symbol can be due to scheduling of another transmission in the symbol or of a reception in the symbol. Whether the counting of repetitions towards a total number of repetitions K (or N for TB processing over multiple slots, or N·K for TB processing over multiple slots with repetitions) is updated when a repetition is not transmitted may depend on a configuration of the counting method and/or on the type of signals that overlap with the repetition.

For example, when a UE is configured with counting of available slots, for unpaired spectrum the availability of a slot can be based on tdd-UL-DL-ConfigurationCommon, tdd-UL-DL-ConfigurationDedicated, if provided, and ssb-PositionsInBurst, and a slot is not counted in the number of K (or N for TB processing over multiple slots, or N·K for TB processing over multiple slots with repetitions) slots for PUSCH transmission if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst. For paired spectrum and SUL band, a slot scheduled or configured for PUSCH transmission or PUCCH transmission is assumed to be available and the counting of repetitions is based on physical slots. It is also possible that the UE operates in half-duplex mode (HD-FDD UE) and determines that a slot is not counted in the number of K, N, or N·K slots for a PUSCH transmission if at least one of the symbols indicated by the indexed row of the used resource allocation table in the slot overlaps with a symbol of an SS/PBCH block with index provided by ssb-PositionsInBurst.

When a UE is configured for operation in duplex mode, the availability of an XDD slot can be based on an XDD slot format configuration and on the capability of the UE to transmit and receive simultaneously in an XDD slot. The UE configured for operation in duplex mode can be provided an XDD slot format configuration that configures symbols as UL, DL or XDD symbols, or be provided the XDD slot format configuration that configures symbols as X symbols in addition to a TDD UL-DL slot format configuration that configures symbols as UL, DL or flexible symbols. If the UE is not capable to transmit and receive simultaneously in an XDD slot, a slot can be unavailable for the PUSCH transmission if at least one of the symbols indicated by the indexed row of the used resource allocation table in the slot overlaps in time with a symbol of an SS/PBCH block with index provided by ssb-PositionsInBurst, independently on whether there is an overlap in frequency between the scheduled SS/PBCH block and the scheduled repetition. If the UE is capable of transmitting and receiving simultaneously, the availability of the slot depends on whether frequency resources of the SS/PBCH block overlap with the frequency resources scheduled for the PUSCH transmission within the configured resources for UL for the slot. Thus, there is a need to determine the availability of an XDD slot for PUSCH or PUCCH transmission based on an XDD slot format configuration that can include UL, DL or XDD slots and on an overlapping with reception of an SS/PBCH block.

Additionally or alternatively to a TDD UL-DL configuration and/or an XDD configuration, time and frequency resources can be dynamically indicated by a gNB and an overlap in time and/or in frequency of transmission and reception is determined based on slot configuration and dynamic indication. Thus, there is another need to determine the availability of an XDD slot for PUSCH or PUCCH transmission based on a dynamic indication of a slot format.

The present disclosure relates to uplink transmissions for a UE capable of operating in duplex mode. The present disclosure relates to determining an availability of an XDD slot for a PUSCH or PUCCH transmission and a counting of repetitions. The present disclosure also relates to determining UL or DL time and frequency resources of the XDD slot after an UL transmission is postponed or dropped. The present disclosure also relates to determining the availability of the XDD slot for UL transmission based on RRC configuration and/or indication of a slot format by a DCI format.

Determining an availability of an XDD slot for PUSCH transmission of a repetition when a scheduled resource for PUSCH overlaps with a resource of an SS/PBCH block with index provided by ssb-PositionsInBurst and/or of a PDSCH or a PDCCH.

When a UE is configured for operation in duplex mode and is provided an XDD configuration, and is configured or indicated by a DCI format to transmit a PUSCH with K repetitions, for an XDD slot, if there is an overlap between the PUSCH resource allocation with PRBs containing SS/PBCH block transmission resources the UE shall assume that the PRBs containing SS/PBCH block transmission resources are not available for PUSCH in the OFDM symbols where the UE expects to receive a symbol of an SS/PBCH block with index provided by ssb-PositionsInBurst. A symbol indicated by ssb-PositionsInBurst can be unavailable for PUSCH transmission when the PRBs containing SS/PBCH block transmission resources occupy same time resources, independently on whether the PUSCH transmission and the SS/PBCH block transmission occupy same or different frequency resources. If the UE is capable of transmitting and receiving simultaneously, when one or more symbols indicated by the indexed row of the used resource allocation table for PUSCH transmission in the slot overlap in time with one or more symbol of an SS/PBCH block with index provided by ssb-PositionsInBurst, in the overlapping symbols the reception of the SS/PBCH block can be in a first portion or sub-band of the frequency resources while the transmission of the uplink channel can be in a second portion or sub-band of the frequency resources that do not overlap with the frequency resources of the first portion or sub-band.

When there is an overlap between the PUSCH resource allocation with PRBs containing reception resources for a DL channel, for example the PDSCH or a PDCCH, over the BWP or over the sub-band of the BWP, the UE shall assume that the PRBs containing the reception resources are not available for PUSCH in the OFDM symbols where the UE expects to receive a symbol of the DL channel in the BWP or in the sub-band of the BWP, respectively. A symbol can be unavailable for PUSCH transmission when one or more PRBs containing the PDSCH or PDCCH reception resources occupy same time resources of the PUSCH and same frequency resources of the PUSCH, or occupy same time resources of the PUSCH and frequency resources within the sub-band. The symbol can be available for PUSCH transmission when one or more PRBs containing the PDSCH or PDCCH reception resources occupy same time resources and different frequency resources of the PUSCH, or occupy same time resources and frequency resources outside the sub-band.

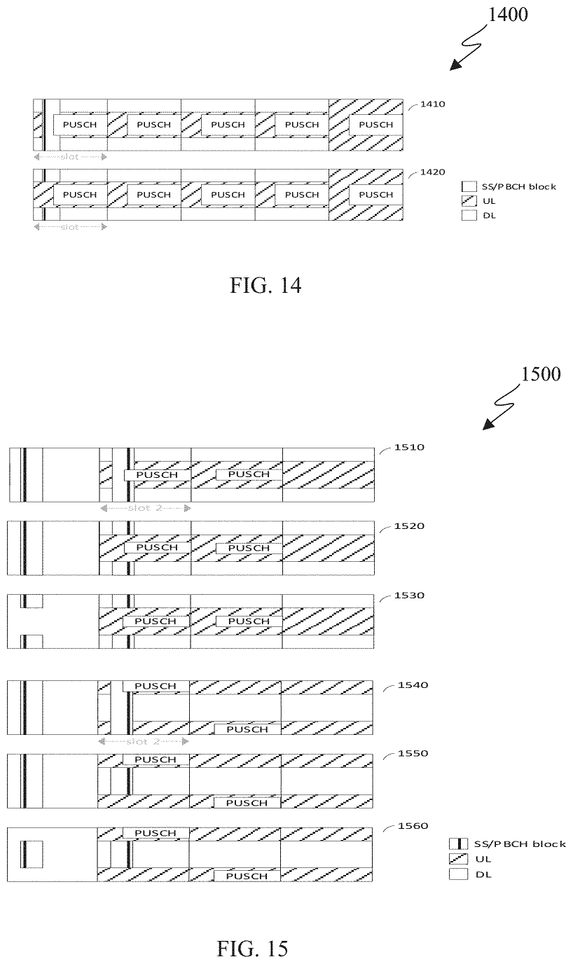

FIG. 14 illustrates an example of a slot configuration 1400 according to embodiments of the present disclosure. The embodiment of the example slot configuration 1400 illustrated in FIG. 14 is for illustration only. FIG. 14 does not limit the scope of this disclosure to any particular implementation of the example slot configuration.

As illustrated in FIG. 14, an XDD configuration can configure frequency resources in a middle portion of a configured BWP for UL (UL sub-band) and the remaining frequency resources for DL (DL sub-band). In 1410, the first slot may be considered unavailable for transmission of the PUSCH due to an overlap in time and frequency resources between SS/PBCH and PUSCH, and when counting of available slot is enabled, the slot is not counted in the number of K slots for PUSCH transmission. In 1420, although there is an overlap of SS/PBCH and PUSCH in time, the first slot may be considered as available for transmission of the PUSCH when the UE is capable of transmitting and receiving simultaneously. The SS/PBCH block, or a PDSCH or a PDCCH, occupies frequencies only in the DL sub-band (or DL sub-bands) that does not overlap with the UL sub-band where the transmission of the PUSCH is scheduled. If the UE is not capable of transmitting and receiving simultaneously, the first slot in 1420 may be considered as unavailable for PUSCH transmission. FIG. 14 further illustrates that for PUSCH repetitions, a UE can be scheduled to transmit a number of repetitions over XDD and UL slots and over same frequencies resources. For example, in 1410 or 1420, the first four slots are XDD slots and the fifth slot is an UL slot, and the fifth PUSCH repetition over the fifth slot is over frequency resources within the sub-band as the first four repetitions in XDD slots.

FIG. 15 illustrates an example of a slot configuration 1500 according to embodiments of the present disclosure. The embodiment of the example slot configuration 1500 illustrated in FIG. 15 is for illustration only. FIG. 15 does not limit the scope of this disclosure to any particular implementation of the example slot configuration.

Whether an SS/PBCH block occupies the entire BWP or only a portion of the BWP can depend on a configuration of SS/PBCH and/or on an XDD configuration. FIG. 15 illustrates examples of SS/PBCH and XDD configurations and a scheduled PUSCH transmission with repetitions, with and without frequency hopping. An XDD configuration can configure frequency resources in the middle part of the BWP for UL and remaining frequency resources for DL, as in 1510, 1520 and 1530, or can configure frequency resources in the middle part of the BWP for DL and remaining frequency resources for UL, as in 1540, 1540 and 1560. FIG. 15 also applies to DL channels other than the SS/PBCH, for example to a PDSCH or a PDCCH.

When an SS/PBCH occupies the entire BWP as in 1510 and 1540, and at least a symbol of a PUSCH repetition overlaps with a symbol of an SS/PBCH block, the slot shall be considered unavailable for transmission of the PUSCH repetition. The first slot in 1510 and 1540 is a DL slot and the SS/PBCH block occupies the entire DL BWP.

In a DL slot, an SS/PBCH block can occupy the entire BWP as in the first slot of 1510, 1520, 1540 and 1550, or can occupy frequencies corresponding to DL sub-bands of an XDD slot configured with an UL sub-band in the middle of the BWP as in the first slot of 1530, or can occupy frequencies corresponding to a DL sub-band of an XDD slot configured with UL sub-bands at both edges of the BWP as in the first slot of 1560. When the SS/PBCH block occupies the DL sub-bands of the BWP configured for XDD slots, as in slot 2 of 1520 and 1530, or occupies the DL sub-band of the BWP configured for XDD slots in XDD slots as in slot 2 of 1550 and 1560, and a symbol of a PUSCH repetition overlaps with a symbol of an SS/PBCH block, the slot shall be considered available for transmission of the PUSCH repetition if the UE is capable to operate in full-duplex mode with simultaneous transmission and reception in a symbol, and shall be considered unavailable for transmission of the PUSCH repetition if the UE is not capable to transmit and receive simultaneously. It is possible that SS/PBCH blocks of a same burst are configured to occupy the same frequency range of a BWP and SS/PBCH blocks of different bursts occupy different frequency ranges of the BWP. It is also possible that SS/PBCH blocks of a same burst are configured to occupy different frequency ranges of the BWP, and the same frequency allocation in one SS/PBCH burst is kept in different SS/PBCH bursts over a period of time.

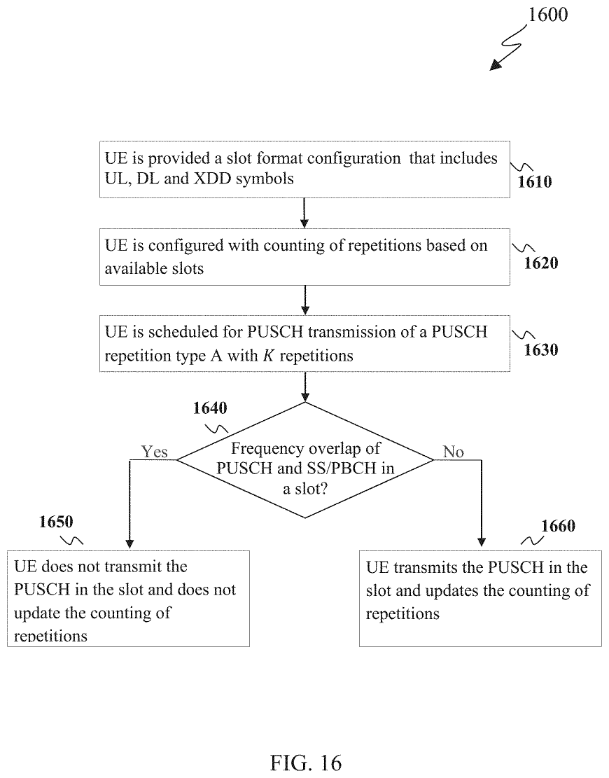

FIG. 16 illustrates an example method 1600 for a UE configured for XDD operation to determine available slots for a PUSCH transmission with repetitions when a counting of number of repetitions is based on available slots according to embodiments of the present disclosure. The embodiment of the example method 1600 for a UE configured for XDD operation to determine available slots for a PUSCH transmission with repetitions when a counting of number of repetitions is based on available slots illustrated in FIG. 16 is for illustration only. FIG. 16 does not limit the scope of this disclosure to any particular implementation of the example method for a UE configured for XDD operation to determine available slots for a PUSCH transmission with repetitions when a counting of number of repetitions is based on available slots.

As illustrated in FIG. 16, at step 1610, a UE is provided a slot format configuration that includes UL, DL and XDD symbols. At step 1620, the UE is configured with counting of repetitions based on available slots. At step 1630, the UE is scheduled for PUSCH transmission of a PUSCH repetition type A with K repetitions. When there is an overlap in frequency between the PUSCH transmission and the SS/PBCH block in a slot at stepm 1640, then at step 1650, the UE does not transmit the PUSCH in the slot and does not update the counting of repetitions. Otherwise, at step 1660, the UE transmits the PUSCH in the slot and updates the counting of repetitions.

When a UE is configured for operation in duplex mode and is configured or indicated by a DCI format to transmit a PUSCH with K repetitions, if a PUSCH resource allocation for a repetition in a first slot includes PRBs containing SS/PBCH block transmission resources or resources associated with a reception of a DL channel, as for example a PDSCH or a PUCCH, wherein the first slot is an XDD slot, the UE shall assume that the PRBs containing SS/PBCH block transmission resources are not available for PUSCH transmission and, depending on whether the UE is configured with a counting of repetitions based on available slots or not, the PUSCH repetition in the first slot is postponed or dropped, respectively. PRBs in an UL sub-band of a BWP of the XDD slot, allocated for transmission of the PUSCH repetition that is postponed or dropped and not including PRBs containing SS/PBCH block transmission resources, can be allocated to other UL transmissions. To optimize resources allocation, such resources can be flexible resources that can be indicated as UL or DL resources by a DCI format. For example, if the SS/PBCH block occupies symbols {2,3,4,5}, and the PUSCH was scheduled in symbols {4,5,6,7,8,9} in the UL sub-band of the BWP, a DCI format can indicate resources in the sub-band in symbols {6,7,8,9} as DL resources. Thus, in an XDD slot resources configured as UL and allocated for a PUSCH transmission that is postponed or dropped can be flexible resources and indicated as DL by a DCI format.

Additionally or alternatively to a presence of PRBs for SS/PBCH or to an overlap of SS/PBCH resources with resources of a PUSCH repetition of a PUSCH transmission in an XDD slot, whether resources configured as UL and allocated for the PUSCH transmission that is postponed or dropped can be flexible resources (and then can be indicated as UL or DL) can depend on the scheduling of the PUSCH transmission and/or the type of PUSCH transmission. In one example, such resources can be flexible resources when the PUSCH transmission of the PUSCH repetition that is postponed or dropped is semi-statically configured, and cannot be flexible resources (and indicated as DL resources) when the PUSCH transmission of the PUSCH repetition that is postponed or dropped is scheduled by DCI format 0_1 or 0_2 in PDCCH with CRC scrambled with C-RNTI, MCS-C-RNTI, CS-RNTI with NDI=1, or the PUSCH transmission of PUSCH repetition Type A is scheduled by DCI format 0_0 with CRC scrambled by TC-RNTI, or the PUSCH transmission of PUSCH repetition Type A is scheduled by RAR UL grant, or the PUSCH transmission is with PUSCH repetition Type B, or the PUSCH transmission of TB processing over multiple slots is scheduled by DCI format 0_1 or 0_2. In another example, such resources can be flexible resources independently of previously being semi-statically configured or dynamically scheduled by a DCI format for the PUSCH transmission of the repetition that is postponed or dropped. It is also possible that the PUSCH transmission can be with K=1 repetitions.

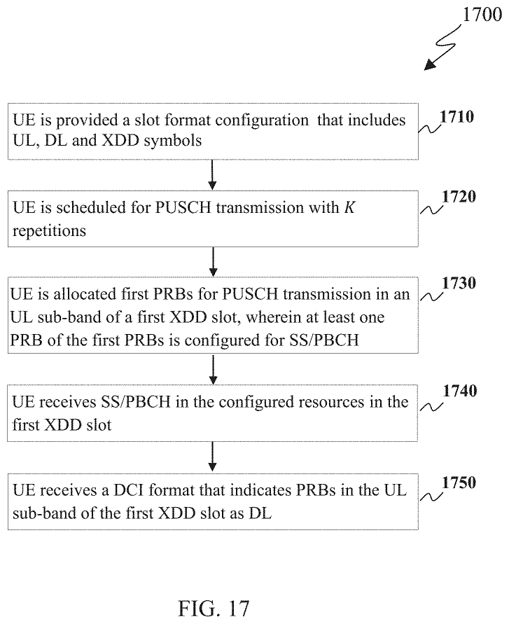

FIG. 17 illustrates an example method 1700 for a UE configured for operation in duplex mode to determine the direction of time and frequency resources based on a dynamic indication according to embodiments of the present disclosure. The embodiment of the example method 1700 for a UE configured for operation in duplex mode to determine the direction of time and frequency resources based on a dynamic indication illustrated in FIG. 17 is for illustration only. FIG. 17 does not limit the scope of this disclosure to any particular implementation of the example method for a UE configured for operation in duplex mode to determine the direction of time and frequency resources based on a dynamic indication.

As illustrated in FIG. 17, at step 1710, a UE (such as the UE 116) is provided a slot format configuration that includes UL, DL and XDD symbols. At step 1720, the UE is scheduled for PUSCH transmission with K repetitions. At step 1730, the UE is allocated first PRBs for PUSCH transmission in an UL sub-band of a first XDD slot, wherein at least one PRB of the first PRBs is configured for SS/PBCH resources. At step 1740, the UE receives SS/PBCH in the configured resources in the first XDD slot. At step 1750, the UE receives a DCI format that indicates PRBs in the UL sub-band of the first XDD slot as DL. Steps 1730 to 1750 also apply when the DL channel is a PDSCH instead of the SS/PBCH.

In the example of FIG. 17, if the UE is configured with counting of PUSCH repetitions based on available slots, the first XDD slot is not counted in the number of K slots for PUSCH transmission of the PUSCH repetition.

In the example of FIG. 17, if the UE does not receive a DCI format that indicates PRBs in the UL sub-band of the first XDD slot as DL, the UE expects to use such PRBs for an UL transmission.

For a UE configured for operation in duplex mode, resources of an XDD slot that are configured as UL by a slot format configuration and that include SS/PBCH blocks with index provided by ssb-PositionsInBurst can be indicated as DL resources by a DCI format. For example, a slot includes two SS/PBCH blocks of four symbols each, and frequency resources in the sub-band configured for UL corresponding to symbols after the first block and not including symbols of the second SS/PBCH block, are indicated as DL resources. If the first SS/PBCH block occupies symbols {2,3,4,5} and the second SS/PBCH block occupies symbols {8,9,10,11}, a DCI format can indicate frequency resources in the UL sub-band in symbols {6,7,12,13} as DL resources. It is also possible that the frequency resources in all symbols of the slot not occupied by an SS/PBCH block can be indicated as DL resources by a DCI format.

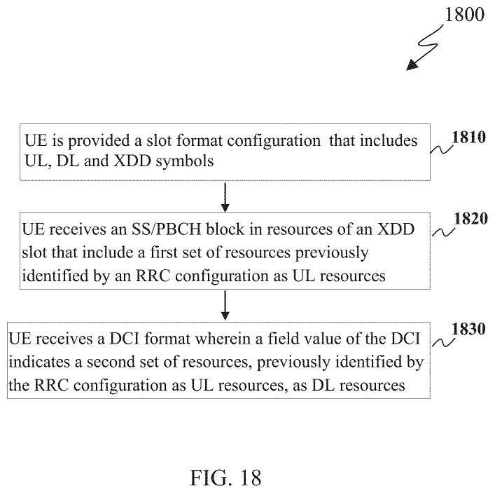

FIG. 18 illustrates an example method 1800 for a UE configured for operation in duplex mode to determine the direction of time and frequency resources based on a dynamic indication according to embodiments of the present disclosure. The embodiment of the example method 1800 for a UE configured for operation in duplex mode to determine the direction of time and frequency resources based on a dynamic indication illustrated in FIG. 18 is for illustration only. FIG. 18 does not limit the scope of this disclosure to any particular implementation of the example method for a UE configured for operation in duplex mode to determine the direction of time and frequency resources based on a dynamic indication.

As illustrated in FIG. 18, at step 1810, a UE (such as the UE 116) is provided a slot format configuration that includes UL, DL and XDD symbols. At step 1820, the UE receives an SS/PBCH block in resources of an XDD slot that include a first set of resources previously identified by an RRC configuration as UL resources. At step 1830, the UE receives a DCI format wherein a field value of the DCI indicates a second set of resources, previously identified by the RRC configuration as UL resources, as DL resources.

A determination of an available slot for PUSCH transmission can be based on an UL-DL TDD and/or an XDD configuration provided by higher layers and possibly adapted by a DCI format with an index field value that indicates to a UE a slot format for each slot in a number of slots Nₛₗₒₜ starting from a slot where the UE detects the DCI format, unless otherwise indicated or RRC configured. The field value of the DCI format indicates both time and frequency resources. It is also possible that the field value of the DCI format indicates time resources and the frequency resources are identified by a frequency range configured by higher layer parameter, wherein the frequency range can be a sub-band of the BWP or the entire BWP.

In a first example, an XDD configuration can configure resources over a number of slots in a sub-band of a configured BWP as UL resources that were previously identified as DL by an UL-DL TDD configuration and that can be used for UL transmission when a DCI format indicates the resources as UL. In absence of the indication by the DCI format, the resources are not available for UL.

In a second example, the XDD configuration can configure resources over the number of slots in the configured BWP as UL resources that were previously identified as DL by an UL-DL TDD configuration and that can be used for UL transmission when a DCI format indicates the resources as UL. In absence of the indication by the DCI format, the resources are not available for UL. Differently for the first example, in the second example the resources that can be indicated by the DCI format as UL resources can occupy the entire BWP.

In a third example, resources in a sub-band of the configured BWP that are identified as DL resources by a first and/or a second configuration, wherein the first configuration is an UL-DL TDD configuration and the second configuration is an XDD configuration, can be used for UL transmission when the DCI format indicates such resources as UL. Additionally or alternatively, the DCI format can be a scheduling DCI for transmission within the sub-band, and resources in the sub-band are used for UL when the UE receives the DCI format that schedules a PUSCH or PUCCH transmission, otherwise resources in the sub-band are DL or flexible resources.

A possible adaptation of a slot format by a DCI format can result in not transmitting one or more PUSCH repetitions in a slot that was previously identified by an RRC configuration as available or can result in transmitting one or more PUSCH repetitions in a slot that was not previously identified by an RRC configuration as available. The possible adaptation of the slot format by the DCI format can determine whether or not an uplink channel is transmitted in a slot.

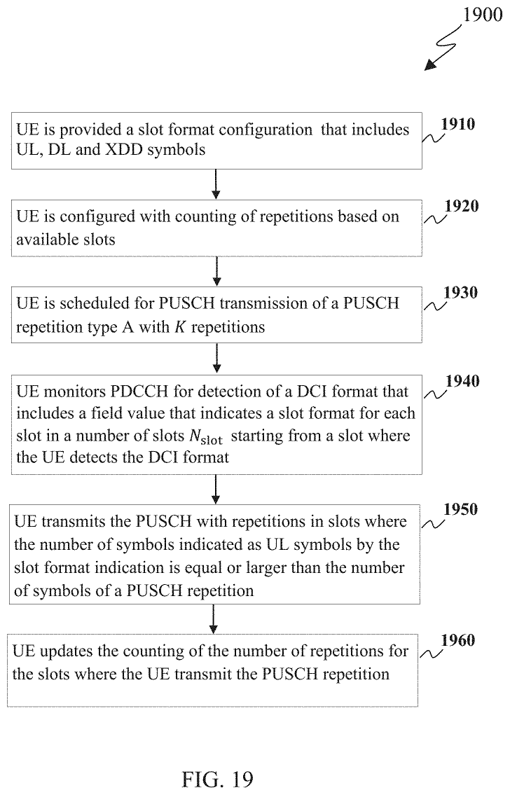

FIG. 19 illustrates an example method 1900 for a UE configured for XDD operation to determine available slots for a PUSCH transmission with repetitions when a counting of number of repetitions is based on available slots according to embodiments of the present disclosure. The embodiment of the example method 1900 for a UE configured for XDD operation to determine available slots for a PUSCH transmission with repetitions when a counting of number of repetitions is based on available slots illustrated in FIG. 19 is for illustration only. FIG. 19 does not limit the scope of this disclosure to any particular implementation of the example method for a UE configured for XDD operation to determine available slots for a PUSCH transmission with repetitions when a counting of number of repetitions is based on available slots.

As illustrated in FIG. 19, at step 1910, a UE (such as the UE 116) is provided a slot format configuration that includes UL, DL and XDD symbols. At step 1920, the UE is configured with counting of repetitions based on available slots. At step 1930, the UE is scheduled for PUSCH transmission of a PUSCH repetition type A with K repetitions. At step 1940, the UE monitors PDCCH for detection of a DCI format that includes a field value that indicates a slot format for each slot in a number of Nₛₗₒₜ slots starting from a slot where the UE detects the DCI format. At step 1950, the UE transmits the PUSCH with repetitions in slots where the number of symbols indicated as UL symbols by the slot format indication is equal or larger than the number of symbols of a PUSCH repetition. At step 1960, the UE updates the counting of the number of repetitions for the slots where the UE transmit the PUSCH repetition.

In step 1910, for an XDD slot the RRC configuration configures a sub-band of the BWP that can be used as UL when the UE receives an indication by a DCI format. For example, a slot is configured as DL by a TDD UL-DL configuration. An XDD configuration configure a sub-band of the BWP in the slot as UL. As illustrated in FIG. 19, upon reception of an indication in a DCI format, resources in the sub-band of the X slot can be used by the UE for transmission. Instead, if no indication is received, the UE is expected to receive in the sub-band of the X slot, according to the TDD UL-DL configuration. Thus, an XDD configuration can define a first sub-band of the BWP, and time and frequency resources that were previously configured as DL in the first sub-band can be indicated as UL by a DCI format. It is possible that the XDD defines a second sub-band of the BWP, and time and frequency resources that were previously configured as UL in the second sub-band can be indicated as DL by a DCI format. It is also possible that first and second sub-bands overlap entirely or partially or do not overlap.

When a UE is configured for operation in duplex mode and is provided an XDD configuration, and is configured or indicated by a DCI format to transmit a PUSCH with K repetitions, in one example an XDD slot can be unavailable for transmission of the PUSCH repetition if there is overlap with another transmission of larger priority. In another example the XDD slot can be unavailable for transmission of the PUSCH repetition if the PUSCH transmission in that slot is canceled by a DCI format providing an uplink cancelation indicator (CI). In both examples, the PUSCH repetition is not transmitted in the XDD slot and the XDD slot is not counted in the number of K slots if a counting of repetitions based on available slot is configured. It is also possible that for an XDD slot if the PUSCH transmission cannot be transmitted due to another uplink transmission of larger priority as in the first example or due to a cancelation of the transmission as in the second example, the XDD slot is not counted in the number of K slots even if the counting of repetitions based on available slot is not configured.

The above descriptions for a PUSCH transmission with K>1 repetitions can apply to PUSCH transmission of a PUSCH repetition type A scheduled by DCI format 0_1 or 0_2 or scheduled by RAR UL grant or scheduled by DCI format 0_0 scrambled by TC-RNTI, to PUSCH transmission of TB processing over multiple slots scheduled by DCI format 0_1 or 0_2, to Type 1 and Type 2 PUSCH transmissions with a configured grant, to PUSCH transmission of TB processing over multiple slots with repetitions, to PUSCH repetition Type B transmission. The above descriptions for the PUSCH transmission with K>1 repetitions also apply for a PUCCH transmission. The uplink channel can also be a PUCCH transmission with HARQ-ACK information corresponding to a DCI format detected by the UE that schedules a SPS PDSCH reception, or schedules a SPS PDSCH release, or indicates SCell dormancy through a PDCCH reception, or requests Type-3 HARQ-ACK codebook report, a PUCCH transmission with SR, or a PUCCH transmission with CSI. A PUCCH transmission can be with repetitions, wherein the UE can be configured a number of slots N_{PUCCH}^{repeat}, for repetitions of the PUCCH transmission, or can be configured a number of repetitions in a PUCCH Resource Indicator (PRI) field.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising a transceiver configured to:
receive information for:
a location of a sub-band (SB) within a bandwidth (BW),
a first set of slots,
a second set of slots, wherein the second set of slots:
is included in the first set of slots, and
does not include slots with receptions of synchronization signals and primary broadcast channel (SS/PBCH) blocks, and
a transmission of a first channel in first frequency resources within the SB over a first set of symbols in a slot of the second set of slots; and
transmit the first channel within the SB over the first set of symbols in the slot, wherein one or more symbols of the first set of symbols in the slot are downlink (DL) symbols according to the information for the first set of slots.

2. The UE of claim 1, wherein the transceiver is further configured to:
receive information for a number of repetitions for the transmission of the first channel within the SB over a third set of slots, wherein the third set of slot includes:
first one or more slots of the first set of slots that are not included in the second set of slots, and
second one or more slots of the second set of slots; and
transmit the repetitions for the transmission of the first channel within the SB in the third set of slots.

3. The UE of claim 1, wherein:
the transceiver is further configured to receive information for a reception of a second channel in second frequency resources over a second set of symbols of the slot;
the UE further comprises a processor operably coupled to the transceiver, the processor configured to determine an availability of the slot for transmission of the first channel based on:
the first and second sets of symbols of the slot, and
the first and second frequency resources; and
the transceiver is further configured to transmit the first channel based on the availability.

4. The UE of claim 3, wherein:
the second set of symbols includes a first symbol of the first set of symbols,
the second frequency resources include resource blocks (RBs) of the first frequency resources, and
the processor is further configured to determine the slot as unavailable.

5. The UE of claim 3, wherein:
the second set of symbols includes a first symbol of the first set of symbols,
the second frequency resources include resource blocks (RBs) of the SB, and
the processor is further configured to determine the slot as unavailable.

6. The UE of claim 3, wherein:
the first channel is a physical uplink shared channel (PUSCH),
the second channel is a physical downlink shared channel (PDSCH),
the second set of symbols includes a first symbol of the first set of symbols,
the second frequency resources do not include resource blocks (RBs) of the SB, and
the processor is further configured to determine the slot as available.

7. The UE of claim 3, wherein:
the transceiver is further configured to receive information for:
a number of repetitions for the transmission of the first channel,
a counter for the number of repetitions to correspond to one of:
a number of consecutive slots, or
a number of transmitted repetitions;
the processor is further configured to determine:
a value of the counter for the number of repetitions, and
an indication for transmitting a repetition for the transmission of the first channel in the slot based on:
the availability, and
the value of the counter for the number of repetitions; and
the transceiver is further configured to transmit the repetition for the transmission of the first channel in the slot within the SB based on the indication.

8. A base station (BS) comprising a transceiver configured to:
transmit information for:
a location of a sub-band (SB) within a bandwidth (BW),
a first set of slots,
a second set of slots, wherein the second set of slots:
is included in the first set of slots, and
does not include slots with transmissions of synchronization signals and primary broadcast channel (SS/PBCH) blocks, and
a reception of a first channel in first frequency resources within the SB over a first set of symbols in a slot of the second set of slots; and
receive the first channel within the SB over the first set of symbols in the slot, wherein one or more symbols of the first set of symbols in the slot are downlink (DL) symbols according to the information for the first set of slots.

9. The BS of claim 8, wherein the transceiver is further configured to:
transmit information for a number of repetitions for the reception of the first channel within the SB over a third set of slots, wherein the third set of slot includes:
first one or more slots of the first set of slots that are not included in the second set of slots, and
second one or more slots of the second set of slots; and
receive the repetitions for the reception of the first channel within the SB in the third set of slots.

10. The BS of claim 8, wherein:
the transceiver is further configured to transmit information for a transmission of a second channel in second frequency resources over a second set of symbols of the slot;
the BS further comprises a processor operably coupled to the transceiver, the processor configured to determine an availability of the slot for reception of the first channel based on:
the first and second sets of symbols of the slot, and
the first and second frequency resources; and
the transceiver is further configured to receive the first channel based on the availability.

11. The BS of claim 10, wherein:
the second set of symbols includes a first symbol of the first set of symbols,
the second frequency resources include resource blocks (RBs) of the SB, and
the processor is further configured to determine the slot as unavailable.

12. The BS of claim 10, wherein:
the first channel is a physical uplink shared channel (PUSCH),
the second channel is a physical downlink shared channel (PDSCH),
the second set of symbols includes a first symbol of the first set of symbols,
the second frequency resources do not include resource blocks (RBs) of the SB, and
the processor is further configured to determine the slot as available.

13. The BS of claim 10, wherein:
the transceiver is further configured to transmit information for:
a number of repetitions for the reception of the first channel,
a counter for the number of repetitions to correspond to one of:
a number of consecutive slots, or
a number of received repetitions;
the processor is further configured to determine:
a value of the counter for the number of repetitions, and
an indication for receiving a repetition for the reception of the first channel in the slot based on:
the availability, and
the value of the counter for the number of repetitions; and
the transceiver is further configured to receive the repetition for the reception of the first channel in the slot within the SB based on the indication.

14. A method comprising:
receiving information for:
a location of a sub-band (SB) within a bandwidth (BW),
a first set of slots,
a second set of slots, wherein the second set of slots:
is included in the first set of slots, and
does not include slots with receptions of synchronization signals and primary broadcast channel (SS/PBCH) blocks, and
a transmission of a first channel in first frequency resources within the SB over a first set of symbols in a slot of the second set of slots; and
transmitting the first channel within the SB over the first set of symbols in the slot, wherein one or more symbols of the first set of symbols in the slot are downlink (DL) symbols according to the information for the first set of slots.

15. The method of claim 14, further comprising:
receiving information for a number of repetitions for the transmission of the first channel within the SB over a third set of slots, wherein the third set of slot includes:
first one or more slots of the first set of slots that are not included in the second set of slots, and
second one or more slots of the second set of slots: and
transmitting the repetitions for the transmission of the first channel within the SB in the third set of slots.

16. The method of claim 14, further comprising:
receiving information for a reception of a second channel in second frequency resources over a second set of symbols of the slot;
determining an availability of the slot for transmission of the first channel based on:
the first and second sets of symbols of the slot, and
the first and second frequency resources; and
transmitting the first channel based on the availability.

17. The method of claim 16, wherein:
the second set of symbols includes a first symbol of the first set of symbols,
the second frequency resources include resource blocks (RBs) of the first frequency resources, and
determining the availability of the slot further comprises determining the slot as unavailable.

18. The method of claim 16, wherein:
the second set of symbols includes a first symbol of the first set of symbols,
the second frequency resources include resource blocks (RBs) of the SB, and
determining the availability of the slot further comprises determining the slot as unavailable.

19. The method of claim 16, wherein:
the first channel is a physical uplink shared channel (PUSCH),
the second channel is a physical downlink shared channel (PDSCH),
the second set of symbols includes a first symbol of the first set of symbols,
the second frequency resources do not include resource blocks (RBs) of the SB, and
determining the availability of the slot further comprises determining the slot as available.

20. The method of claim 16, further comprising:
receiving information for:
a number of repetitions for the transmission of the first channel,
a counter for the number of repetitions to correspond to one of:
a number of consecutive slots, or
a number of transmitted repetitions;
determining:
a value of the counter for the number of repetitions, and
an indication for transmitting a repetition for the transmission of the first channel in the slot based on:
the availability, and
the value of the counter for the number of repetitions; and
transmitting the repetition for the transmission of the first channel in the slot within the SB based on the indication.
